(19) United States
(12) Patent Application Publication
(10) Pub. No.: US 2006/0108794 A1
(43) Pub. Date: May 25, 2006

(54) Trunking and coupling means therefor

(76) Inventor: Richard John Thompson, Wolsingham (GB)

Correspondence Address: Zilka-Kotab, PC, P.O. BOX 721120, SAN JOSE, CA, 95172-1120, US

(21) Appl. No.: 10/519,373

(22) PCT Filed: Apr. 22, 2003
(86) PCT No.: PCT/GB03/01715

§ 371 Date: Aug. 4, 2005

(30) Foreign Application Priority Data
Jul. 3, 2002 (GB) 0215368.2

(51) Int. Cl. F16L 11/118

(52) U.S. Cl. 285/149.1

(57) ABSTRACT

A coupling (30) for coupling a first section of trunking (32) to a second section of trunking (34), has a body (36). The body (36) has first and second elongate members (38) and (40), and defines first surface (42) and second surface (44). The first surface (42) is adapted to engage a first flange (46) on first trunking section (32) and the second surface (44) is adapted to engage a second flange (48) on second trunking section (34). A third surface (50) of body (36) connects the first and second surfaces (42) and (44) and provides a substantially continuous surface with external surfaces (52, 54) and (56) of first trunking section (32) and external surfaces (58, 60) and (62) of second trunking section (34).

The present invention relates to trunking and coupling means therefor, and particularly, not exclusively, to waterproof trunking for carrying electrical cables.

The carrying of electrical cables in a network of trunking is used in many industries. In the food, beverage and pharmaceutical industries, where hygiene is of paramount importance, stainless steel trunking is regularly used. It is important that such trunking is easily cleaned and that places where dirt may gather, and infestation may occur, are kept to a minimum.

In some situations it is necessary to provide a waterproof trunking. For example, where trunking is located near a high ceiling the preferred method of cleaning maybe to direct a jet of water at the trunking from the ground. As a result, the term waterproof is used within this document to refer to the amount of sealing of joints that is required, between parts of the trunking, in order to prevent water penetrating under the circumstances of this type of cleaning.

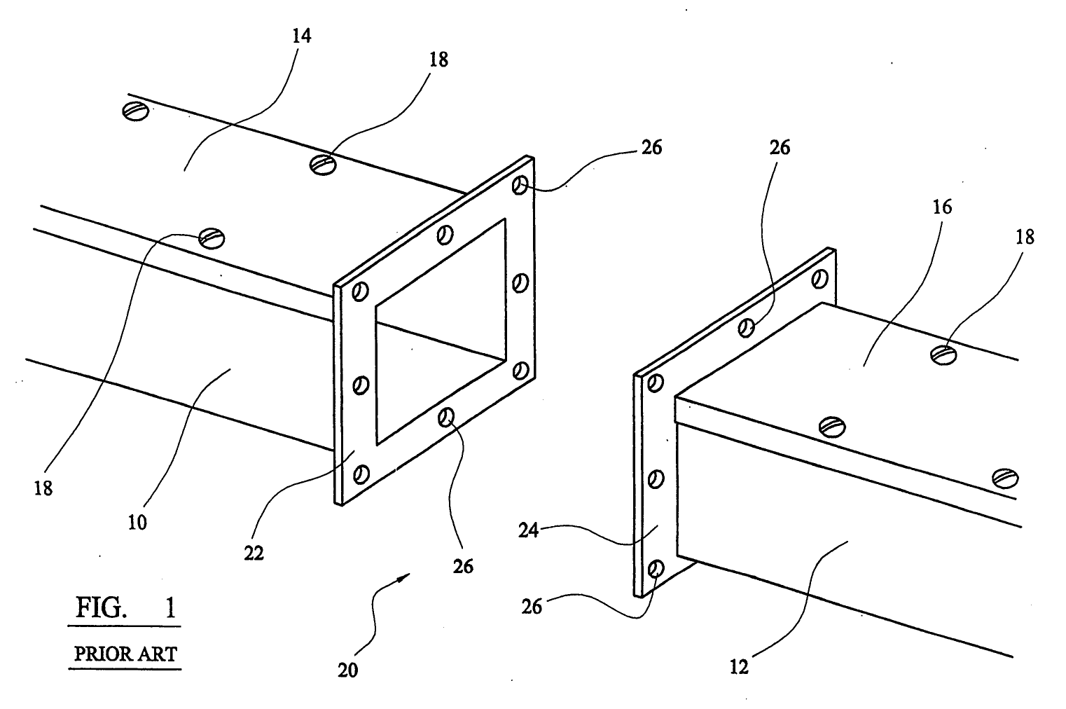

An example of a trunking system of this type is shown in FIG. 1. The trunking shown consists of elongated trunking members 10 and 12 having respective lids 14 and 16. Each lid is retained in position by screws 18 and the junction between members 10 and 12 and respective lids 14 and 16 is sealed with a gasket (not shown). In order to provide an adequate seal for the waterproofing required it is necessary to provide a large number of screws 18. If only a few screws 18 are used the lids 14 and 16 buckle along their edges, providing gaps which allow water inside the trunking members 10 and 12. As a result of the large number of screws used to provide this seal, the time taken to install this waterproof trunking is significant.

A coupling 20 is used to join trunking members 10 and 12. The coupling 20 consists of first coupling plate 22, attached to trunking member 10 and a second coupling plate 24 attached to trunking member 12. When brought together, the coupling plates 22 and 24 are sealed using a gasket seal (not shown). The coupling plates 22 and 24 are fixed together using screws in holes 26. This form of coupling creates a significant number of dirt traps around the edge of plates 22 and 24 and in holes 26. The gasket is also exposed around all of the edge of plates 22 and 24, providing a further dirt trap.

This type of trunking also has the disadvantage that when the sections of trunking are joined together and lids 14 and 16 removed to enable cables to be laid into the trunking sections, it is necessary to pass the cables through the openings in flanges 22 and 24.

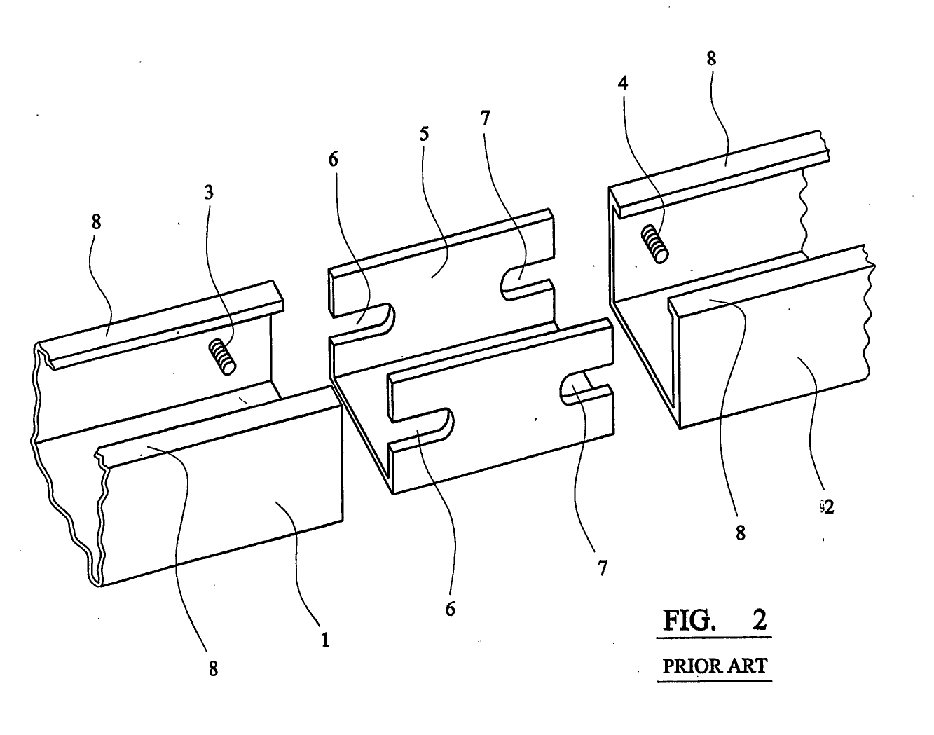

An alternative trunking system used in the above mentioned industries is shown in FIG. 2. Such a system, for joining two lengths of trunking 1 and 2, utilises am internal fixing mechanism consisting of a coupling 5, having slots 6 and 7 cut therein. These slots align with threaded studs 3 and 4 onto which bolts (not shown) are tightened thus holding the coupling 5 in engagement with trunking lengths 1 and 2. This system provides a smooth joint between the trunking sections 1 and 2, therefore allowing the outside surfaces of the trunking to remain free from dirt traps. However, this system has only four fixing points to join two sections of trunking, and as a result such joints in a trunking system are unsuitable for spanning a distance greater then a single length of trunking unsupported. Furthermore, if one or more of the four fixing points are not sufficiently tightened the trunking sections can be easily separated.

Preferred embodiments of the present invention seek to overcome the above described disadvantages of the prior art.

According to an aspect of the present invention there is provided a coupling member for coupling a first section of trunking to a second section of trunking, the coupling member comprising:

a body having first and second elongate members, the body defining first and second surfaces adapted to respectively engage a first flange on a first section of trunking and a second flange on a second section of trunking, and a third surface connecting said first and second surfaces and adapted to provide a substantially continuous surface with respective external surfaces of said first and second sections of trunking in use; and

at least one connecting member for joining distal ends of said first and second elongate members.

A coupling of the type described above has the advantage that it allows the easy connection of two lengths of trunking having an internal flange around three sides. Because the flange only extends around three sides of a rectangular trunking used with this coupling, and the first and second surfaces similarly only extend around three sides of the coupling when cables are placed into the trunking they can be laid along several joined sections of trunking without having to be fed through holes in the ends of the trunking. Also, a strong and stable connection between lengths of trunking can be made. For example, if two of the screws used to connect the internal flange of the trunking section to the coupling are not properly Lightened the trunking will remain joined since the other screws will maintain the joint and seal. Furthermore even if all of the screws were loose the joint would still remain since the screws would not be pulled out. Whereas in the prior art shown in FIG. 2, the connection is maintained by a frictional force and thus if bolts are not tightened the strength of the joint is lost. When the connecting means is added it provides additional stabilisation for the body of the coupling, for the trunking attached Lo the body of the coupling and for the junction between the lids. For example, because the connecting portion is located at the junction between two lids, a threaded hole can be put into the connecting portion allowing the centre of the end of the lids to be secured in position with a screw or bolt. Thus, because the connecting portion is removable, an open channel along a number of coupled trunking sections can be produced having the advantage that cables can be easily laid therein, whilst the reintroduction of the connecting portion provides the additional stability to the trunking system as a whole. By producing a continuous surface between the first and second trunking sections the advantage is provided that the external surfaces of the trunking sections connected to the coupling are easy to clean. In particular, when compared to the prior art shown in FIG. 1, it is clear that the number of dirt traps is significantly reduced by having the fixing means, screws and bolts internally of the trunking sections. Furthermore, a continuous surface between adjacent trunking sections and the coupling therebetween provides an easily wiped clean surface which is not possible in the trunking of the prior art in FIG. 1.

In a preferred embodiment said first and second surfaces have retaining means adapted to retain said surfaces in engagement with respective first and second flanges.

In another preferred embodiment the distal ends of first and second elongate members further comprise retaining means adapted to engage retaining means in said connecting member.

Said retaining means may be holes adapted to receive screws or bolts therein.

In a preferred embodiment at least some of said holes have an internal thread therein adapted to engage a respective thread on said screw or bolt.

In a preferred embodiment said body is substantially U-shaped and said connecting member is substantially linear.

In a preferred embodiment said coupling further comprises a guide means extending from a fourth surface, connecting said first and second surfaces and opposing said third surface, the guide means adapted to extend within at least one of said first or second trunking sections.

By providing the coupling with a guide means the advantage is provided that the internal surface of the adjoined trunking sections onto which cables are laid is somewhat smoothed when compared to the use of flanges alone.

In a preferred embodiment the guide means is adapted to be bent towards internal surfaces of said trunking sections.

The coupling may further comprise at least one gasket seal.

According to another aspect of the present invention there is provided a section of waterproof trunking comprising:

a body portion defining at least one inlet for a cable, and having at least one aperture for allowing access to an inside of said body portion, wherein the or each said aperture is adapted to receive a respective cover means thereon; and

a flange provided on at least one respective said inlet, extending internally thereof and adapted to engage at least one further trunking section.

By providing a trunking section as described above, the advantage is provided that when-a number of trunking sections are joined together using retaining means attached to or as part of the flange, a strong connection between adjacent trunking sections and a substantially smooth and continuous external surface in particular at the junction between the trunking sections which is therefore easy to clean as well as being strong and stable. In particular with the removal of the external screws and bolts the number of dirt traps is significantly reduced.

In a preferred embodiment the aperture extends along more than 95% of the length of the side.

In another preferred embodiment said cover means is a lid adapted to cover all of said side containing said aperture and to extend at least partially along two adjacent sides of the section.

In a preferred embodiment the or each flange extends from said side substantially perpendicular to said side.

The flange may be a single flange extending from all of the sides.

The trunking section may further comprise a guide means extending from said flange towards an internal section of said trunking section and adapted to extend within a further trunking section.

By providing the coupling with a guide means the advantage is provided that the internal surface of the adjoined trunking sections onto which cables are laid is somewhat smoothed when compared to the use of flanges alone.

In a preferred embodiment the guide means is adapted to be bent towards internal surfaces of said further trunking section.

The trunking section may further comprise at least one gasket seal attached to the or each flange.

According to a further aspect of the present invention there is provided a section of waterproof trunking comprising:

a body portion having at least one inlet for a cable, wherein at least one inlet comprising a respective open channel; and

a respective flange extending inwardly of at least one said channel; and

a respective flange extending inwardly of at least one said channel and adapted to engage at least one further trunking section.

By providing a trunking section as described above the advantage is provided that the external surfaces of such trunking sections when joined to a further trunking section either with or without a coupling means therebetween, are smooth and substantially continuous providing a surface which is easy to clean. Such joints are strong as a result of the use of screws or bolts as retaining means between respective flanges or a flange and a coupling means. Furthermore such strong joints are less likely to leak especially when sealed.

The trunking section may further comprise three substantially planar sides arranged perpendicular to each other.

In another preferred embodiment side portions extend toward each other from two of said three planar sides and thereby define an opening to said open channel.

In a preferred embodiment said trunking section is retained to a further trunking section by a coupling means.

The trunking section may further comprise at least one gasket seal.

According to an aspect of the present invention there is provided a trunking system comprising:

at least one first section of waterproof trunking having a body portion having at least one inlet for a cable, wherein at least one inlet comprising a respective open channel, a respective flange extending inwardly of at least one said channel, and a respective flange extending inwardly of at least one said channel and adapted to engage at least one further trunking section;

at least one respective lid for covering said channel; and

at least one coupling member for coupling said first section of trunking to a second section of trunking, the coupling member having a body having first and second elongate members, the body defining first and second surfaces adapted to respectively engage a first flange on a first section of trunking and a second flange on a second section of trunking, and a third surface connecting said first and second surfaces and adapted to provide a substantially continuous surface with respective external surfaces of said first and second sections of trunking in use, and at least one connecting member for joining distal ends of said first and second elongate members.

Preferred embodiments of the present invention will now be described, by way of example only and not in any limitative sense, with reference to the accompanying drawings in which:

FIG. 1 is a perspective view of an example of trunking sections of the prior art;

FIG. 2 is a perspective view of another example of trunking sections of the prior art;

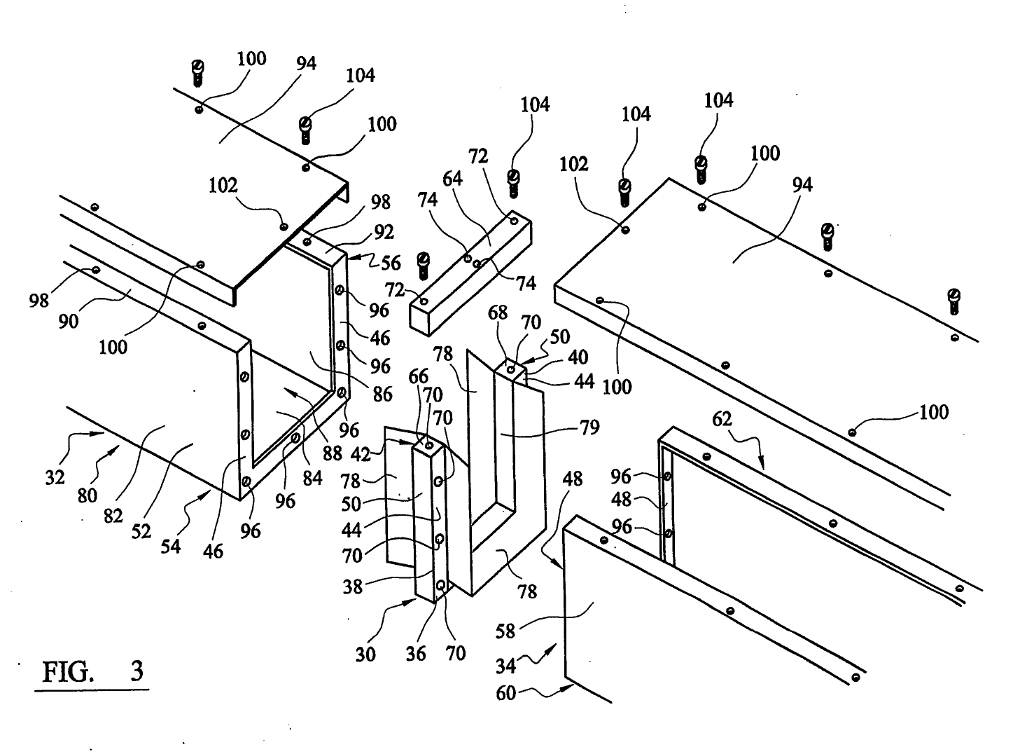

FIG. 3 is an exploded perspective view of trunking members and a coupling of the present invention;

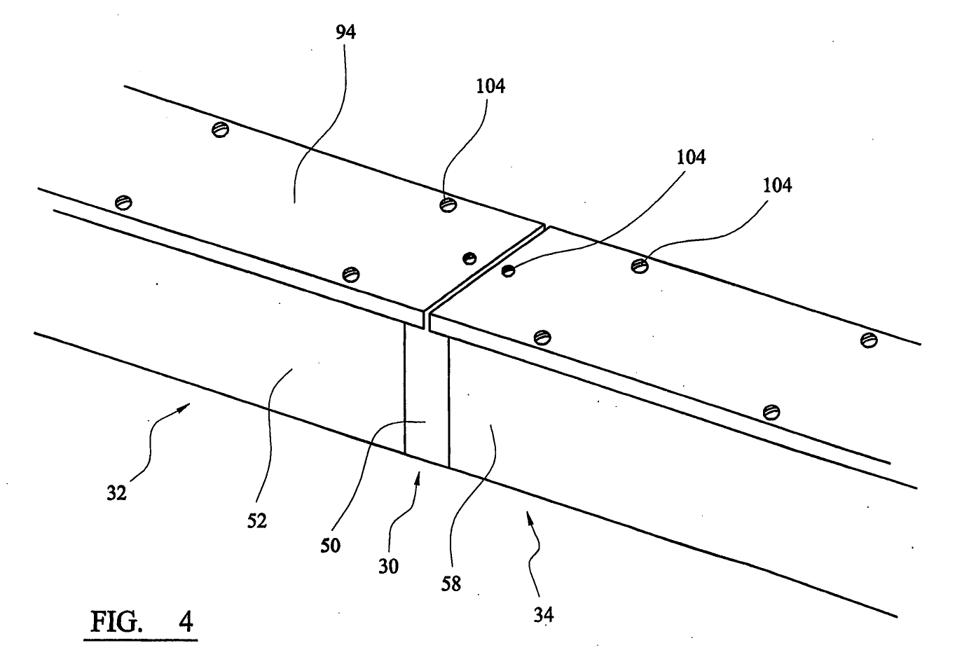

FIG. 4 is a perspective view of the trunking and coupling of FIG. 3;

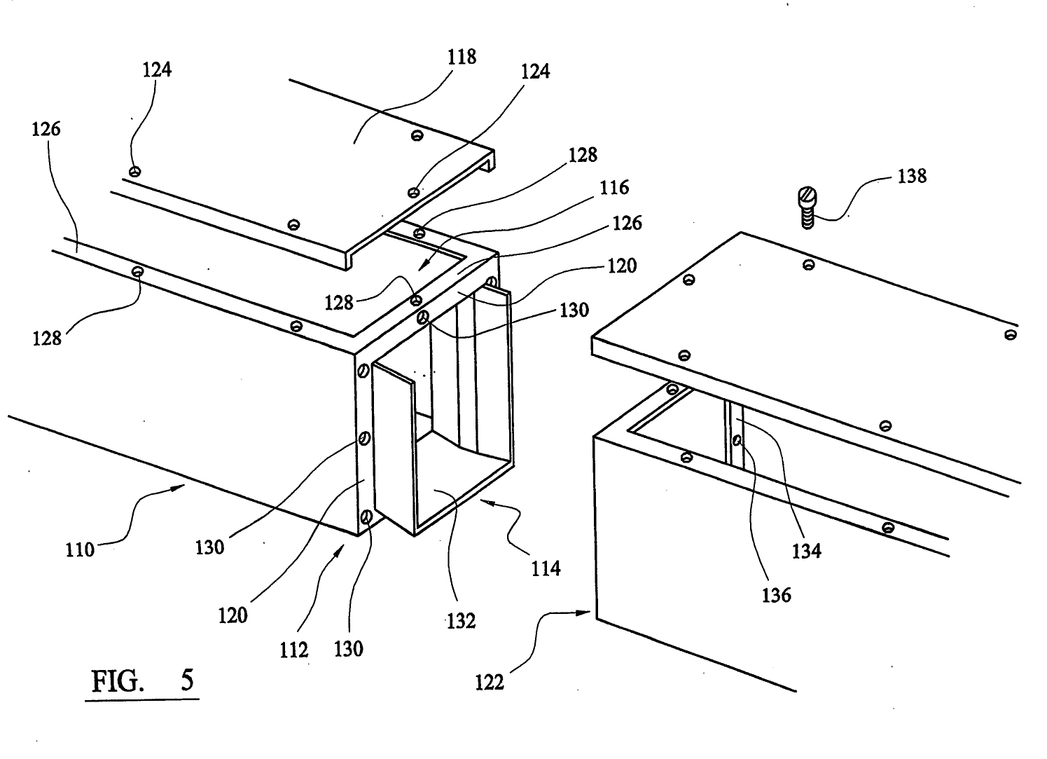

FIG. 5 is an exploded perspective view of trunking sections of the present invention; and

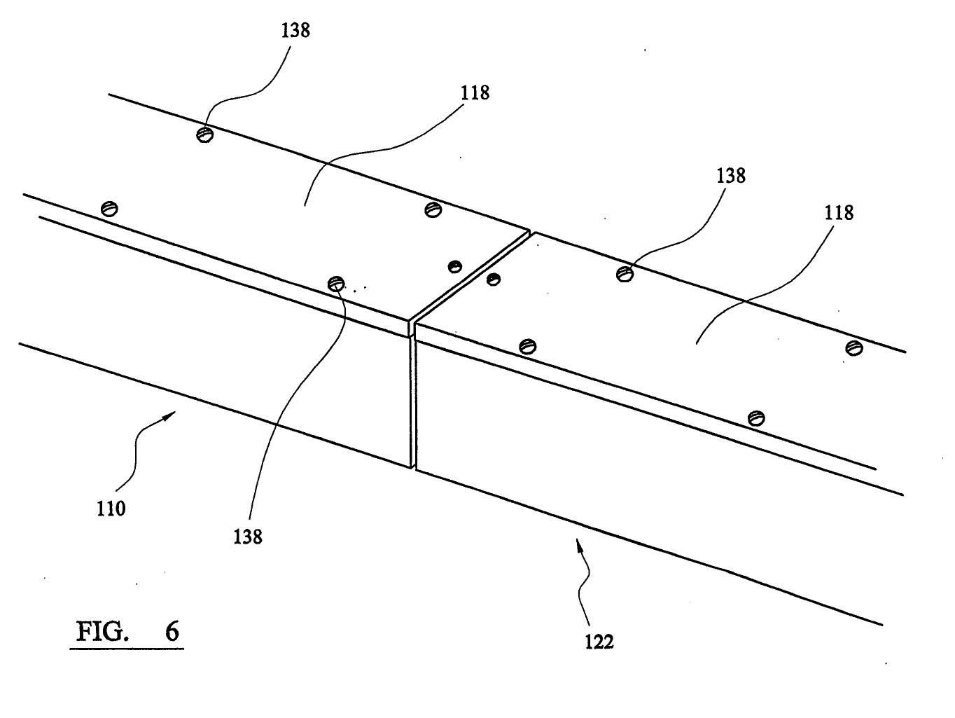

FIG. 6 is a perspective view of the trunking sections of FIG. 5.

Referring to FIGS. 3 and 4 a coupling 30, for coupling a first section of trunking 32 to a second section of trunking 34, has a body 36. The body 36 has first and second elongate members 38 and 40, and defines first surface 42 and second surface 44. The first surface 42 is adapted to engage a first flange 46 on first trunking section 32 and the second surface 44 is adapted to engage a second flange 48 on second trunking section 34. A third surface 50 of body 36 connects the first and second surfaces 42 and 44 and provides a substantially continuous surface with external surfaces 52, 54 and 56 of first trunking section 32 and external surfaces 58, 60 and 62 of second trunking section 34.

The coupling 30 also has a connecting member 64 for joining distal ends 66 and 68 of first and second elongate members 38 and 40. Body 36 is also provided with retaining means in the form of threaded holes 70. Connecting member 64 has retaining means, in the form of holes 72, and further retaining means, in the form of threaded holes 74. Body 36 has a guide means 78 extending from fourth surface 79.

Trunking section 32 has a body 80 formed from three sides 82, 84 and 86 having respective surfaces 52, 54 and 56 and has at least one inlet 88 for a cable extending into an open channel. A flange 46 extends inwardly of said inlet 88 and is adapted to engage at least one further trunking section. Sides 80 and 86 have respective side portions 90 and 92 extending towards each other. Trunking section 32 is adapted to receive a lid 94. Flange 46 has retaining means in the form of non-threaded holes 96 and side portions 90 and 92 have retaining means in the form of threaded holes 98. Lid 94 has holes 100 and 102 therein holes 70, 72, 74, 96, 98, 100 and 102 are all adapted to receive screws 104.

In use coupling 30 is brought into engagement with trunking sections 32 and 34 such that first surface 42 engages first flange 46. Screws or bolts (not shown) are inserted through holes 96 and into holes 70 on first surface 42. Second flange 48 of second trunking 34 is engaged with second surface 44 and screws or bolts (not shown) extend through holes 96 and into threaded holes 70. Guide means 78 is then bent towards the internal surfaces of the first and second trunking sections 32 and 34. As a result, there is provided an open channel into which cables may be laid.

Once the laying of the cables is complete connecting member 64 is attached to body 36 by screws 104 extending through holes 72 and into threaded holes 70. Lids 94 are then located over trunking members 32 and 34 and screws 104 inserted through holes 100 into holes 98. Further screws 104 are inserted through holes 102 and into holes 74 on connecting member 64.

FIG. 4 shows that a continuous surface is formed between the surfaces 52, 50 and 58 and that the number of dirt traps, for example screws in holes, has been significantly reduced when compared to the coupling of the prior art.

In an alternative embodiment the coupling 30 may be removed and trunking sections 32 and 34 may be connected to each other directly. However, it would then be necessary to cover the junction between the lids 94 of first and second trunking sections 32 and 34 with some form of cover plate in order that this junction is sealed.

Referring to FIGS. 5 and 6, a section of trunking 110 has a body portion 112 defining at least one inlet for a cable 114 and having at least one aperture 116 for allowing access to the inside of said body portion 112, the aperture being adapted to receive a cover means in the form of lid 118. The trunking also has a flange 120 provided on inlet 114 and extending internally thereof, the flange 120 being adapted to engage a further trunking section 122. Lid 118 is provided with unthreaded holes 124 and an edge portion 126 adjacent aperture 116 is provided with threaded holes 128. Flange 120 is provided with threaded holes 130. Inlet 114 has a guide means 132 extending therefrom. Second trunking section 122 has a second flange 134 having unthreaded holes 136 therein.

In use first trunking section 110 is brought into engagement with second trunking section 112 such that flanges 120 and 134 engage. Screws or bolts, like that shown at 138, are inserted through holes 130 and into threaded holes 136 to retain the trunking sections 110 and 122 together. Guide means 132 is bent towards internal surfaces of trunking section 122 so as to provide a smooth transition over flanges 120 and 134. Once two or more trunking sections are connected together, cables can be inserted. A cable is inserted into aperture 116 and passed through inlet 114. Once all cables are in position lids 118 are located over trunking sections 110 and 122. Screws or bolts 138 are inserted through holes 124 and engaged with holes 128.

It will be appreciated by persons skilled in the art that the above embodiment has been described by way of example only, and not in any limitative sense, and that various alterations and modifications are possible without departure from the scope of the invention as defined by the appended claims.

1-25. (canceled)

26. A coupling member for coupling a first section of trunking to a second section of trunking, the coupling member comprising:
a body having first and second elongate members, the body defining first and second surfaces adapted to respectively engage a first flange on a first section of trunking and a second flange on a second section of trunking, and a third surface connecting said first and second surfaces and adapted to provide a substantially continuous surface with respective external surfaces of said first and second sections of trunking in use; and
at least one connecting member for joining distal ends of said first and second elongate members.

27. A coupling according to claim 26, wherein said first and second surfaces have at least one retaining device adapted to retain said surfaces with respective first and second flanges.

28. A coupling according to claim 26, wherein said distal ends of first and second elongate members further comprise at least one retaining device adapted to engage at least one said retaining device in said connecting member.

29. A coupling according to claim 27, wherein at least one said retaining device comprises at least one hole adapted to receive a respective screw or bolt therein.

30. A coupling according to claim 29, wherein at least one said hole further comprises an internal thread therein adapted to engage a respective thread on said screw or bolt.

31. A coupling according to claim 26, wherein said body is substantially U-shaped and said connecting member is substantially linear.

32. A coupling according to claim 26, further comprising at least one guide device extending from a fourth surface, connecting said first and second surfaces and opposing said third surface, at least one said guide device being adapted to extend within at least one of said first or second trunking sections.

33. A coupling according to claim 32, wherein at least one said guide device is adapted to be bent towards internal surfaces of said trunking sections.

34. A coupling according to claim 26, further comprising at least one gasket seal.

35. A section of waterproof trunking comprising:
a body portion defining at least one inlet for a cable, and having at least one aperture for allowing access to an inside of said body portion, wherein the or each said aperture is adapted to receive a respective cover device thereon; and
a flange provided on at least one respective said inlet, extending internally thereof and adapted to engage at least one further trunking section.

36. A trunking section according to claim 35, wherein said aperture extends along more than 95% of the length of a side.

37. A trunking section according to claim 35, wherein at least one said cover device is a lid adapted to cover all of said side containing said aperture and to extend at least partially along two adjacent sides of the section.

38. A trunking section according to claim 37, wherein the or each flange extends from said side substantially perpendicular to said side.

39. A trunking section according to claim 35, wherein said flange is a single flange extending from all sides of the trunking section.

40. A trunking section according to claim 35, further comprising at least one guide device extending from said flange towards an internal section of said trunking section and adapted to extend within a further trunking section.

41. A trunking section according to claim 40, wherein at least one said guide device is adapted to be bent towards internal surfaces of said further trunking section.

42. A trunking section according to claim 35, further comprising at least one gasket seal attached to the or each flange.

43. A section of waterproof trunking comprising:
a body portion having at least one inlet for a cable, wherein at least one inlet comprising a respective open channel; and
a respective flange extending inwardly of at least one said channel; and
a respective flange extending inwardly of at least one said channel and adapted to engage at least one further trunking section.

44. A section of trunking according to claim 43, further comprising three substantially planar sides arranged perpendicular to each other.

45. A section of trunking according to claim 43, wherein side portions extend toward each other from two of said three planar sides and thereby define an opening to said open channel.

46. A section of trunking according to claim 43, wherein said trunking section is retained to a further trunking section by at least one coupling device.

47. A section of trunking according to claim 43, further comprising at least one gasket seal.

48. A trunking system comprising:
at least one first section of waterproof trunking having a body portion having at least one inlet for a cable, wherein at least one inlet comprising a respective open channel, a respective flange extending inwardly of at least one said channel, and a respective flange extending inwardly of at least one said channel and adapted to engage at least one further trunking section;
at least one respective lid for covering said channel; and
at least one coupling member for coupling said first section of trunking to a second section of trunking, the coupling member having a body having first and second elongate members, the body defining first and second surfaces adapted to respectively engage a first flange on a first section of trunking and a second flange on a second section of trunking, and a third surface connecting said first and second surfaces and adapted to provide a substantially continuous surface with respective external surfaces of said first and second sections of trunking in use, and at least one connecting member for joining distal ends of said first and second elongate members.
